(19) United States
(12) Patent Application Publication
(10) Pub. No.: US 2022/0269472 A1
(43) Pub. Date: Aug. 25, 2022

(54) Acoustic Gunshot Replicator

(71) Applicant: US Gov't as represented by Secretary of Air Force, Wright-Patterson AFB, OH (US)

(72) Inventor: Avi Nusimow, Fort Walton Beach, FL (US)

(21) Appl. No.: 17/169,910

(22) Filed: Feb. 8, 2021

Related U.S. Application Data
(60) Provisional application No. 63/145,085, filed on Feb. 3, 2021.

(51) Int. Cl. G06F 3/16; H04R 1/08; F41A 33/04

(52) U.S. Cl. CPC G06F 3/165; H04R 1/08; F41A 33/04

(57) ABSTRACT

An acoustic gunshot replicator device includes a microphone attachable proximate to a barrel of a firearm to sense a sound caused by a gunshot by the firearm. The device includes an audio output device configured to replicate the sound. The device includes a recording device that is communicatively coupled to the microphone and the audio output device and that is configured to record the sound sensed by the microphone and playback the recorded sound using the audio output device. A record control attachable to the firearm is communicatively coupled to the recording device to prompt recording of the sound in response to a first user input. A playback control attachable to the firearm is communicatively coupled to the recording device to prompt playback of the sound in response to a second user input.

### CROSS-REFERENCE TO RELATED APPLICATIONS

This application claims the benefit of priority under 35 U.S.C. § 119(e) to: (i) U.S. Provisional Application Ser. No. 63/145,085 entitled “Acoustic Gunshot Replicator,” filed 3 Feb. 2021, the contents of both of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to sound recording and playback devices, and more particularly to sound recording and playback devices capable of replicating gunshot sounds from a fireman.

### 2. Description of the Related Art

Military members, security guards, law enforcement personnel use personal firearms as part of the duties. Individuals rely on personal firearms for self-defense. Personal firearms carry a limited number of rounds internally or in a magazine. An adversary, knowing this limitation, may choose to advance while the user is reloading and unable to return fire. The adversary can also remain concealed or behind cover until the all of the ammunition is expended.

### BRIEF SUMMARY

In one aspect, the present disclosure provides an acoustic gunshot replicator device includes a microphone attachable proximate to a barrel of a firearm to sense a sound caused by a gunshot by the firearm. The device includes an audio output device configured to replicate the sound. The device includes a recording device that is communicatively coupled to the microphone and the audio output device and that is configured to record the sound sensed by the microphone and playback the recorded sound using the audio output device. A record control attachable to the firearm is communicatively coupled to the recording device to prompt recording of the sound in response to a first user input. A playback control attachable to the firearm is communicatively coupled to the recording device to prompt playback of the sound in response to a second user input. In another aspect, the present disclosure provides an augmented firearm assembly of a firearm with the fire acoustic gunshot replicator device incorporated or attached.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a right side view of an augmented fire arm assembly of a firearm with attached acoustic gunshot replicator device, according to one or more embodiments; and

FIG. 2 illustrates a functional block diagram of the acoustic gunshot replicator device of FIG. 1, according to one or more embodiments.

### DETAILED DESCRIPTION

According to aspects of the present disclosure, an acoustic gunshot replicator device uses self-calibrating omnidirectional microphones with sufficient sampling rate and bandwidth to capture the high amplitude and short duration gunshot impulses. Actual gunshot signals are digitized, recorded, and made available to the replicator for playback using the push pad mounted on the firearm grip. A series of directional speakers are utilized to overcome the inverse square law that limits the distance of conventional speakers. The parametric loudspeakers will project the focused replicated gunshot sounds when triggered by the grip pressure pad play button. In one or more embodiments, the speakers are capable of transmission at peak pressures ranging from 0.1 to 1.0 psi measured at 1 meter from the firearm in order to replicate the pressure wave fronts. The focused parametric interaction gun sound will ensure the intended recipient is the focused target of the deception. All the components are powered by a portable power supply making the device self-contained and portable.

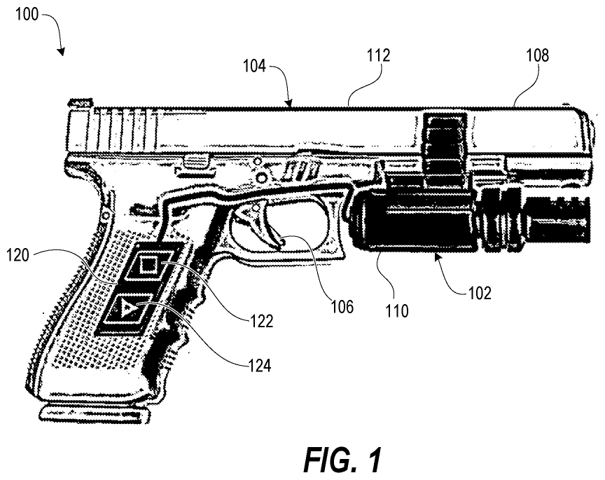

FIG. 1 illustrates a right side view of augmented fire arm assembly 100 that consists of acoustic gunshot replicator (AGR) device 102 attached to firearm 104. Augmented fire arm assembly 100 enables a user to selectively live fire firearm 104 using gun trigger 106 or to simulate a gunshot using AGR device 102. In one or more embodiments, acoustic gunshot replicator device 102 is attachable to firearm 104. In one or more embodiments, acoustic gunshot replicator device 102 is incorporated within an outer frame 108 of firearm 104. In one or more embodiments, acoustic AGR 102 is carried in proximity to firearm 104. Acoustic gunshot replicator device 102 includes housing 110 having bracket that engages or is fastened to an underside of outer frame 108 forward of gun trigger 106. In one or more embodiments, AGR device 102 can be mounted on top rail 112 of firearm 104 or in other lateral positions.

In one or more embodiments, user control module 120 is exteriorly presented on housing 110 or remotely attachable to a convenient position on outer frame 108 of firearm 104. Placement can enable fluidly switching between use gun trigger 106 and use of user control module 120 without inadvertently depressing gun trigger 106 or interfering with handgrip support of firearm 104. In one or more embodiments, user interface module 120 includes record control 122 and playback control 124.

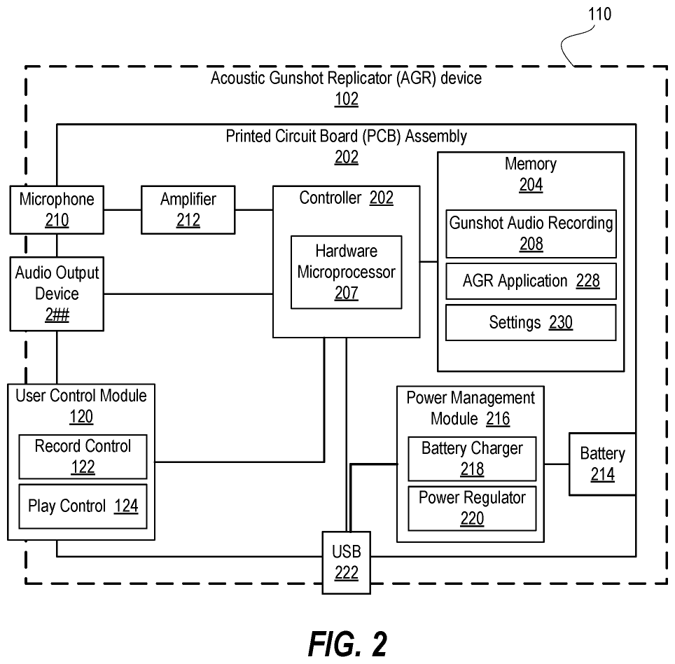

FIG. 2 is a schematic block diagram of AGR device 102. In one or more embodiments, AGR device 102 includes a printed circuit board (PCB) assembly 202 that interconnects functional components that are protected by housing 110. Controller 204, also referred to as a microcontroller, controls operations of AGR device 102. Memory 206 is coupled to controller 204 for storing program code and data generated and used by at least one hardware microprocessor 207 controller 204. In one or more embodiments, memory 206 includes a SD card that is provisioned with one or more selectable gunshot audio recordings 208 that can be matched with a particular firearm 104 (FIG. 1). In one or more embodiments, memory 206 includes an embedded rewriteable memory that stores gunshot audio recording 208 detected by microphone 210. Microphone 210 can be directly coupled to controller 204 for receiving audio generated by firearm 104. Microphone 210 can be indirectly coupled to controller 204, being supplemented by amplifier 212 connected between microphone 210 and controller 204. Amplifier 212 can include automatic gain control (“AGC”). AGR device 102 includes battery 214 is provided supplying power to the PCB assembly 202 and its components. Battery 214 can be one or more a rechargeable lithium ion batteries. Power management module 216 includes battery charger 218 for charging battery 214, and power regulator 220 for maintaining a voltage to the functional components of PCB assembly 202. Universal serial bus (USB) connector 222 can provide power to power management module 216 and data to controller 204. AGR device 102 includes audio output device 224 such as a speaker that capable of replicating a gunshot acoustic sound, such as a found having a peak pressure in a range of 0.1 to 1.0 psi measured at one meter from firearm 104.

In one or more embodiments, playback control 124 causes controller 204 to execute AGR application 228 contained in memory 206 that accesses one of gunshot audio recordings 208 and causes playback on audio output device 224. In one or more embodiments, a most recent gunshot audio recordings 208 is played. In one or more embodiments, setting 230 in memory 206 designates a selected one of gunshot audio recordings 208 for playback. In one or more embodiments, Record control 124 of user control module 120 activates controller 204 to monitor for a gunshot, buffering an audio recording until a sufficiently loud sound is detected. Controller 204 clips and records the sensed gunshot audio recording 208 by detecting the beginning of the sound pulse.

By virtue of the present disclosure, the real time gunshot recording and realistic acoustic playback takes into account environmental sound variations due to different firearms, ammunitions, wind, temperature gradients, humidity, atmospheric absorption & scattering. The current state of microphones, digital processing, and speakers allows the replicator to be relatively small in size/weight enabling the entire device to be resident and triggered from the firearm itself. The replicator can be integral to new firearms or made available as an add-on similar to current firearm accessories such as lasers, optics, pistol grip, bi-pods, or illuminators.

In one or more embodiments, self-calibrating omnidirectional microphones can be used with sufficient sampling rate and bandwidth to capture the high amplitude and short duration gunshot impulses. Actual gunshot signals are digitized, recorded, and made available to the replicator for playback using the push pad mounted on the firearm grip. A series of directional speakers can be utilized to overcome the inverse square law that limits the distance of conventional speakers. The parametric loudspeakers will project the focused replicated gunshot sounds when triggered by the grip pressure pad play button. The focused parametric interaction gun sound ensures the intended recipient is the focused target of the deception. All the components can be powered by a portable power supply making the device self-contained and portable.

In one or more embodiments, AGR device 102 is made by integrating readily available sub-system technologies while simultaneously taking into account human factors for the shooter. AGR device 102 does not interfere with normal shooting operations. For example, AGR device 102 can have weight balancing, non-interference with sights, ease of triggering, etc. AGR device 102 is set for recording or playback via dual zone pressure pads on the firearm grip. The firearm run trigger 106 continues to be used exclusively for live shots with the pressure pads enabled for recording. When the user desires to engage the acoustic replicator feature, the push pad playback button is engaged while the firearm trigger remains untouched. This ensures the firearm trigger is always used for live rounds as a safety feature to prevent inadvertent firings. The microphone and speakers are resident in a housing can be attached to the “picatinny” rail aluminum shroud mounting system that fits over the barrel. The mounting system can be a universal and scalable design allowing it to be added to a variety of pistols, revolvers, tactical and sporting rifles, and shotguns. AGR device 102 can be used in a variety of applications such as scarce/limited ammunition, non-lethal force, deception, and training/exercises. The user is able to seamlessly switch back and forth between live ammo and replicated gunshots which are realistic and indistinguishable by the human ear to live ammunition sounds.

In one or more embodiments, AGR device 102 can be a unit that does not attach to the firearm but rather is placed in close proximity for optimal recording and playback. This is for situations where firearm accessories are not appropriate. A variation to this is a two-piece unit comprising a first piece that includes a microphone and recorder and a second piece that includes a speaker system. The second piece is a separate unit that can be placed in different location(s) with a wireless streaming link. This enables various deception techniques to be employed from a single location. In one or more embodiments, the present innovation can be employed multiple simultaneous speaker systems to create replicated gunshots from multiple vectors of varying distances.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1. An acoustic gunshot replicator device comprising:
a microphone attachable proximate to a barrel of a firearm to sense a sound caused by a gunshot by the firearm;
an audio output device configured to replicate the sound;
a recording device communicatively coupled to the microphone and the audio output device and that is configured to record the sound sensed by the microphone and playback the recorded sound using the audio output device;
a record control attachable to the firearm and communicatively coupled to the recording device to prompt recording of the sound in response to a first user input; and
a playback control attachable to the firearm and communicatively coupled to the recording device to prompt playback of the sound in response to a second user input, wherein the acoustic gunshot replicator device produces a first sound that sounds like a first gunshot when attached to a first firearm and produces a second sound that sounds like a second gunshot when attached to a second firearm that is different from the first firearm.

2. The acoustic gunshot replicator device of claim 1, wherein the sound has a peak pressure in a range of 0.1 to 1.0 psi measured at one meter from the firearm.

3. An augmented firearm assembly comprising:
a firearm that when fired by a gun trigger shoots a projectile that causes a sound of a gunshot, the firearm configurable with different types of ammunition or muzzle attachments to produce more than one gunshots including a first gunshot and a second gunshot that sounds different to the first gunshot; and
an acoustic gunshot replicator device attached to the firearm and comprising:
a microphone that senses the sound caused by the gunshot by the firearm;
an audio output device configured to replicate the sound;
a recording device communicatively coupled to the microphone and the audio output device and that is configured to record the sound sensed by the microphone and playback the recorded sound using the audio output device;
a record control attachable to the firearm and communicatively coupled to the recording device to prompt recording of the sound in response to a first user input; and
a playback control attachable to the firearm and communicatively coupled to the recording device to prompt playback of the sound in response to a second user input, wherein the acoustic gunshot replicator device produces a first sound that sounds like the first gunshot when the firearm is configured to produce the first gunshot and produces a second sound that sounds like the second gunshot when the firearm is configured to produce the second gunshot.

4. The augmented firearm assembly of claim 3, wherein the sound has a peak pressure in a range of 0.1 to 1.0 psi measured at one meter from the firearm.
